(19) United States
(12) Patent Application Publication
(10) Pub. No.: US 2007/0080604 A1
(43) Pub. Date: Apr. 12, 2007

(54) ELECTRIC FAN

(75) Inventors: CHIH-HAO YANG, Tu-Cheng,Taipei Hsien (TW); CHAO-NIEN TUNG, Tu-Cheng,Taipei Hsien (TW); FONG-TAN YU, Tu-Cheng,Taipei Hsien (TW); CHIUNG-MEI WANG, Tu-Cheng,Taipei Hsien (TW); CHUEN-SHU HOU, Tu-Cheng,Taipei Hsien (TW); TAY-JIAN LIU, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng,Taipei Hsien (TW)

(21) Appl. No.: 11/308,915

(22) Filed: May 25, 2006

(30) Foreign Application Priority Data
Aug. 5, 2005 (CN) 200510036430.X

(51) Int. Cl. H02K 7/00; H02K 21/12

(52) U.S. Cl. 310/257; 310/67 R; 310/156.26; 310/156.38

(57) ABSTRACT

An electric fan includes a frame (10) having a central tube (11) extending therefrom, a bearing (30) received in the central tube, a stator (50) mounted around the central tube, and a rotor (70) being rotatably supported by the bearing received in the central tube. The frame defines an air inlet (19) and an air outlet (17) at two different sides thereof. The stator includes two poles (51, 53) and a tube (55) arranged between the poles. Each pole includes a basewall (511, 531) and a sidewall (513, 533) extending from the basewall. Each sidewall includes an upper portion adjacent to the air inlet expanding radially along a direction from the air inlet to the air outlet of the electric fan.

### FIELD OF THE INVENTION

The present invention relates to an electric fan, and more particularly to a motor for an electric fan.

### DESCRIPTION OF RELATED ART

With the continuing development of electronic technology, electronic packages such as CPUs (central processing units) are generating more and more heat that requires immediate dissipation. Electric cooling fans are commonly used in combination with heat sinks for cooling the CPUs.

Referring to FIG. 10, a conventional electric cooling fan includes a stator 6, a rotor 8 rotatable with respect to the stator 6, and a fan housing 2 receiving the rotor 8 and stator 6 therein. The stator 6 is approximately cylinder-shaped and typically includes a stator core 62 and stator coils 64 wound around the stator core 62. The stator core 62 consists of layered yokes. Each yoke includes a ring shaped center portion and a plurality of pole members extending outwardly from the center portion for winding the coils thereon. To avoid the coils 64 electrically contacting with the stator core 62, upper and lower insulating frames 66, 68 cover the stator core 62 and electrically insulate the stator coils 64 from the stator core 62. The rotor 8 includes a hub 82 surrounding the stator 6. The hub 82 includes a flat, disc-shaped top wall 81 and a cylinder-shaped sidewall 83 extending downwardly from an outer-periphery of the top wall 81. A plurality of fan blades 86 extends outwardly from the sidewall 83, and a cylinder-shaped permanent magnet 84 is attached to an inner surface of the sidewall 83 of the hub 82. A shaft 88 extends downwardly from a central portion of the top wall 81 into a bearing 4 mounted in the fan housing 2. During operation of the fan, an alternating magnetic field established by the stator 6 interacts with a magnetic field of the permanent magnet 84 to drive the rotor 8 to rotate, thereby generating an airflow via the fan blades 86.

For enhancing the amount of airflow generated by the fan, one way is to increase the size of the blades 86. However, this way will increase the size of the cooling fan, which is disadvantageous in view of miniaturization requirement of electronic products. Another way is to reduce the diameter of the hub 82. However, the yokes of the stator core 62 are formed by stamping silicon-steel sheets, each of which has a flat configuration and a predetermined diameter; thus, the size and the shape of the stator core 62 are almost fixed and difficult to be altered. Due to the fixed size and shape of the stator 6, the shape and size of the rotor 8 including the hub 82 are also almost fixed and difficult to be altered. For the conventionally-shaped hub 82, a turbulent flow is produced in the area of an air inlet of the conventional electric fan, which significantly affects the pressure and the speed of the airflow. Furthermore, the flat, disc-shaped top wall 81 of the hub 82 forms a barrier for the airflow through the fan, whereby flow rate of the airflow is adversely affected. Accordingly, the airflow provided by the conventional electric fan cannot efficiently dissipate heat absorbed by a heat sink from a heat-generating electronic component away from the heat sink.

What is needed, therefore, is an electric fan having a relatively lager amount of airflow and a relatively smaller size.

### SUMMARY OF THE INVENTION

According to a preferred embodiment of the present invention, an electric fan includes a frame having a central tube extending therefrom, a bearing received in the central tube, a stator mounted around the central tube, and a rotor being rotatably supported by the bearing received in the central tube. The frame defines an air inlet and an air outlet at two different sides thereof. The stator includes two poles and a tube arranged between the poles. Each pole includes a basewall and a sidewall extending from the basewall. Each sidewall includes an upper portion adjacent to the air inlet expanding radially along a direction from the air inlet to the air outlet of the electric fan. The rotor includes a hub and a plurality of blades extending an outer-periphery of the hub. An upper portion of the hub expands radially along the flow direction from the basewall of the stator. Thus the hub has a streamline shaped outer surface with the smallest diameter facing the air inlet of the fan; the flow resistance of the airflow is reduced and the turbulent flow and noise are avoided. The fan blades of the rotor have a larger size and thus can generate a larger amount of airflow. Finally a greater amount of airflow with increased speed and pressure is generated, and the heat dissipating effectiveness of the electric fan is improved.

Other advantages and novel features of the present invention will be drawn from the following detailed description of a preferred embodiment of the present invention with attached drawings, in which:

### BRIEF DESCRIPTION OF THE DRAWINGS

Many aspects of the present electric fan can be better understood with reference to the following drawings. The components in the drawings are not necessarily drawn to scale, the emphasis instead being placed upon clearly illustrating the principles of the present electric fan. Moreover, in the drawings, like reference numerals designate corresponding parts throughout the several views:

FIG. 1 is an isometric, assembled view of an electric fan in accordance with a preferred embodiment of the present invention;

FIG. 2 is an isometric, explored view of the electric fan of FIG. 1;

FIG. 3 is a cross-sectional view of the electric fan of FIG. 1;

FIG. 4 is an isometric, assembled view of a stator of the electric fan of FIG. 1;

FIG. 5 is an explored view of the stator of FIG. 4;

FIG. 6 is an isometric, assembled view of a second embodiment of the stator;

FIG. 7 is an explored view of the stator of FIG. 6;

FIG. 8 is an isometric, assembled view of a third embodiment of the stator;

FIG. 9 is an exploded view of the stator of FIG. 8; and

FIG. 10 is a cross-sectional view of a conventional electric fan.

### DETAILED DESCRIPTION OF THE INVENTION

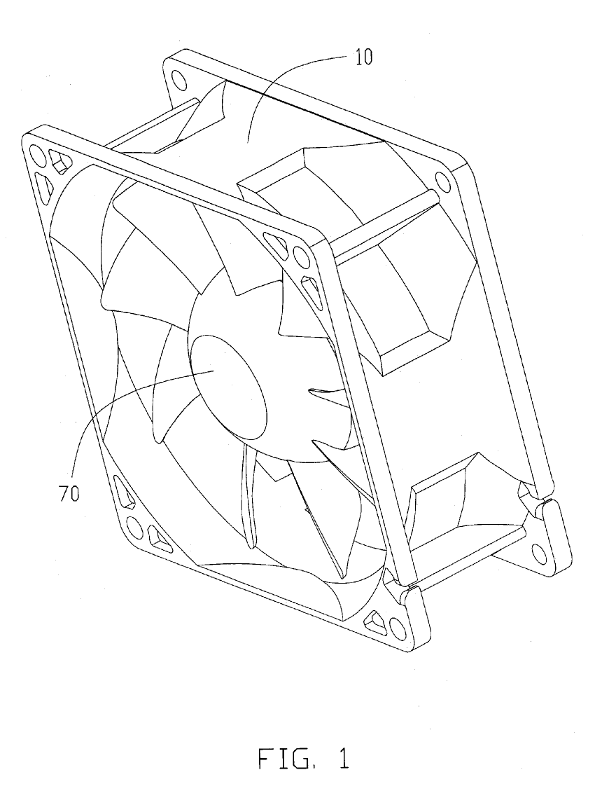

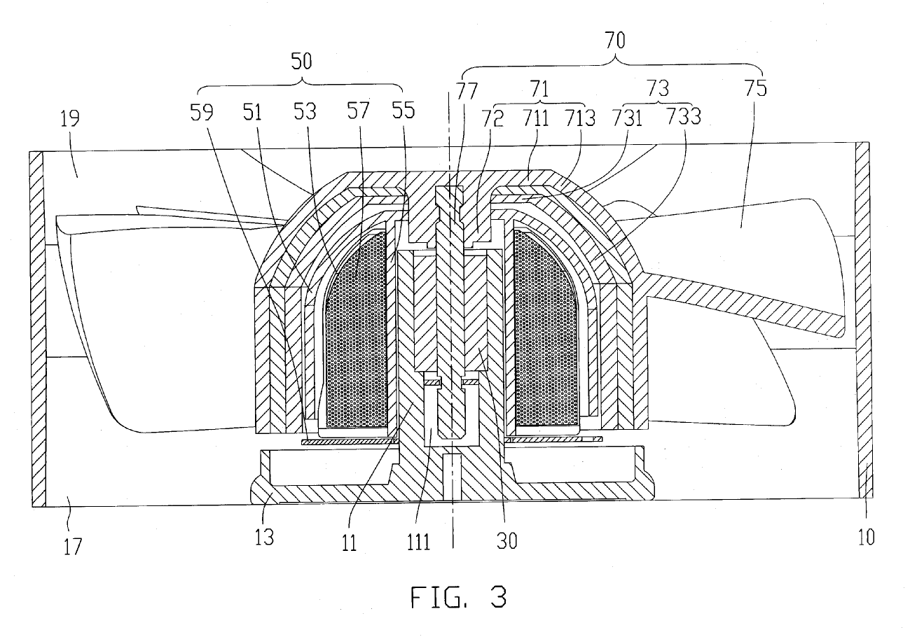

Referring to FIGS. 1 through 3, an electric fan according to a first embodiment of the present invention includes a rotor 70, a stator 50 in respective to which the rotor 70 is rotatable, a frame 10 receiving the rotor 70 and the stator 50 therein, and a bearing 30 mounted in the frame 10 for supporting the rotor 70 to rotate.

The frame 10 is square shaped. An air inlet 19 and air outlet 17 are defined at two opposite sides of the frame 10. An airflow generated by the fan flows from the air inlet 19 to the air outlet 17. The frame 10 includes a base 13 adjacent to the air outlet 17. A central tube 111 extends upwardly from a central portion of the base 13. The central tube 11 defines a central hole 111 receiving the bearing 30 therein. An axial hole 31 is defined in the bearing 30.

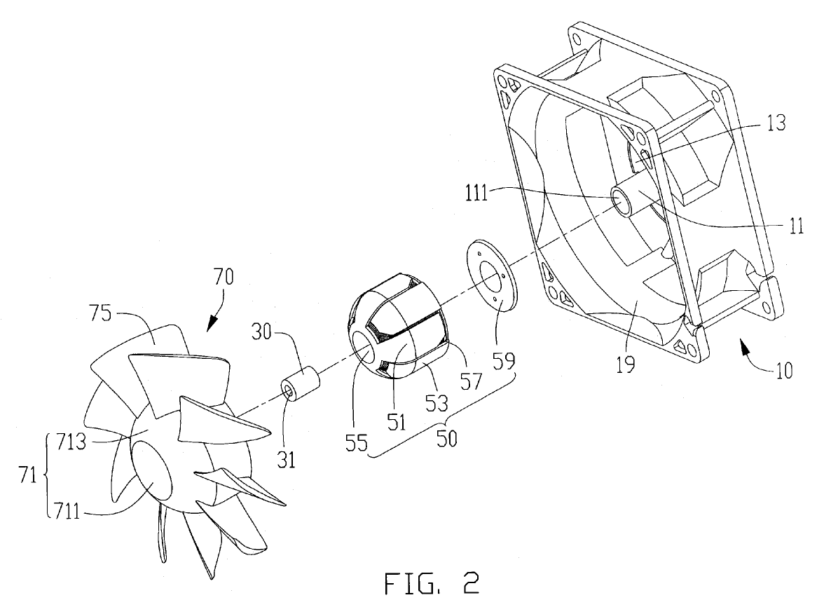

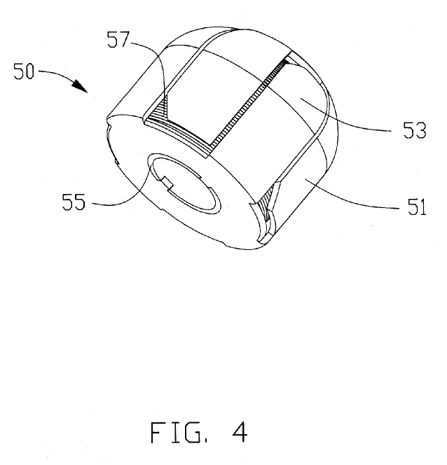

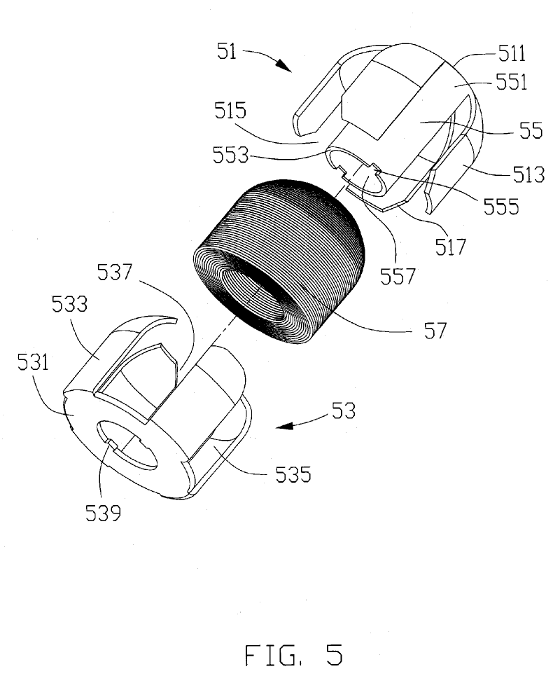

Referring to FIGS. 4 and 5, the stator 50 is mounted around the central tube 11. The stator 50 includes upper and lower poles 51, 53, a tube 55 interconnecting the upper and lower poles 51, 53, axial windings 57 wound around the tube 55, and a PCB (printed circuit board) 59 (FIG. 2) electrically connecting with the windings 57. The tube 55 is formed integrally with the upper pole 51. A top end 551 of the tube 55 adjacent to the air inlet 19 is integrated into the upper pole 51, and a bottom end 553 adjacent to the air outlet 17 extends to the lower pole 53. A pair of openings 555 is defined in the bottom end 553 of the tube 55 for locking the tube 55 with the lower pole 53 together. A through hole 557 is defined in the tube 55 for mounting the stator 50 to the frame 10.

The upper and lower poles 51, 53 are arranged facing to each other. Each of the poles 51, 53 includes a ring-shaped basewall 511, 531. The ring-shaped basewalls 511, 531 are connected to top and bottom ends 551, 553 of the tube 55, respectively. Sidewalls 513, 533 respectively extend from an outer-periphery of the basewalls 511, 531 of each of the poles 51, 53 to the other pole 53, 51. A circular hole (not labeled) is defined in a central portion of each basewall 511, 531 of the poles 51, 53 and communicates with the through hole 557 of the tube 55. A pair of latches 539 extends inwardly from an inner circumference of the basewall 531 of the lower pole 53 corresponding to the openings 555 of the tube 55. The basewall 531 of the lower pole 53 has an outer diameter relatively larger than that of the basewall 511 of the upper pole 51. An upper portion of each of the sidewalls 513, 533 adjacent to the air inlet 19 expands radially from the basewall 511 of the upper pole 51 to the basewall 531 of the lower pole 53. A lower portion of the sidewalls 513, 533 adjacent to the air outlet 17 is approximately cylinder-shaped. Alternatively, the lower portion of the sidewalls 513, 533 of the poles 51, 53 can expand in the same way as the upper portion and thus the sidewalls 513, 533 can be of hemi-spherical or hemi-ellipsoidal shape. In other words, the diameter of each sidewall 513, 533 gradually increases along a direction from the top end 551 to the bottom end 553 of the tube 55. Each sidewall 513, 533 has a diameter which at the narrowest point is about the same as the outer diameter of the basewall 511 of the upper pole 51 at the top end 551 of the tube 55, and at the widest point has a diameter about the same as the outer diameter of the basewall 531 of the lower pole 53 at the bottom end 553 of the tube 55. A distance between the sidewalls 513, 533 and the tube 55 is gradually increased along the flowing direction of the airflow from the air inlet 19 to the air outlet 17. Cooperatively the sidewalls 513, 533 and the tube 55 define a space for receiving the windings 57 which expands radially along the flowing direction of the airflow therethrough. Also an upper portion of the windings 57 has an arc-shaped figure corresponding to the upper portion of the sidewalls 513, 533 of the poles 51, 53. Four grooves 515, 535 are defined in each of the sidewalls 513, 533 and divide each of the sidewalls 513, 533 into four parts. The four parts of each sidewall 513, 533 are evenly spaced along a circumferential direction thereof. A cutout 517, 537 is defined in a free end of each part spaced from the basewalls 513, 533 so as to help the electric fan to start smoothly.

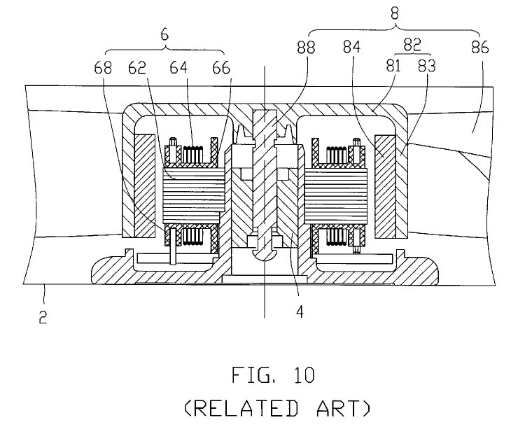

The rotor 70 covers the stator 50 therein and has a profile generally conforming to the profile of the poles 51, 53 of the stator 50. The rotor 70 includes a hub 71 having a planar shaped topwall 711 forming a shaft seat 72 at a central portion and a sidewall 713 extending downwardly and outwardly from an outer-periphery of the topwall 711, a shaft 77 received in the shaft seat 72 and extending downwardly therefrom to be rotatably received in the bearing 30, a plurality of fan blades 75 extending radially from the sidewall 713 of the hub 71, and a permanent magnet 73 adhered to an inner wall of the sidewall 713 of the hub 71 to establish a magnetic field. According to the shape of the hub 71, the permanent magnet 73 has a top wall 731 with a shape of a flat ring, facing the basewall 511 of the upper pole 51 of the stator 50, and an arc-shaped sidewall 733 facing the sidewalls 513, 533 of the poles 51, 53. The outer diameter of the sidewall 713 of the hub 71 (also the sidewall 733 of the permanent magnet 73) gradually increases along the flow direction of the airflow. The lower portion of the sidewall 713 of the hub 71 adjacent to the air outlet 17 has a diameter relatively larger than that of the topwall 711 of the hub 71 adjacent to the air inlet 19. In other words, an outer surface of the sidewall 713 of the hub 71 is approximately dome-shaped. Thus, the turbulent flow occurring at the inlet of the conventional electric fan can be avoided in the present invention and the flow resistance of the airflow is reduced. The hub 71 occupies a space which is smaller than that of the hub 82 of the conventional electric fan of FIG. 10 when the hub 82 has a diameter the same as that of the hub 71 measured at a bottom end thereof. Thus the blades 75 of the rotor 70 can have a relatively larger size than that of the blades 86 of the conventional electric fan of FIG. 10 when the electric fan in accordance with the present invention and the conventional fan have the same size. Accordingly, the amount of airflow generated by the fan blades 75 is greatly increased.

When the fan assembly is assembled together, each part of the sidewalls 513, 533 is received in a corresponding groove 535, 515 of the other sidewall 533, 513. The parts of the sidewalls 513, 533 are alternately arranged along the circumferential direction of the poles 51, 53. Each latch 539 engages with a corresponding opening 555 of the tube 55. Thus the stator 50 is assembled together. The assembled stator 50 is mounted around the central tube 11 of the frame 10 with the central tube 11 extending through the through hole 557 of the tube 55. The bearing 30 is mounted into the central hole 111 of the central tube 11. The axial hole 31 of the bearing 30 receives the shaft 77 therein to support the rotor 70 during rotation. During operation, the axial windings 57 wound around the tube 55 establish an alternating magnetic field which interacts with the magnetic field of the permanent magnet 73 of the rotor 70 thus driving the rotor 70 to rotate. The rotating fan blades 75 of the rotor 70 generate airflow to dissipate heat from a heat source. For the larger size of the fan blades 75, a relatively larger amount of airflow is generated by the electric fan of the present invention. As the airflow flows through the electric fan to the heat source, the flowing resistance is lowered due to the streamlined shape of the outer surface of the hub 71. Also the turbulent flow and noise are generally avoided. The speed and pressure of the airflow are increased. After leaving the air outlet 17, the larger amount of airflow with increased speed and pressure blows onto the heat source and takes away the heat of the heat source effectively. Thus, the flow rate of the airflow and the heat dissipating effectiveness of the electric fan are improved.

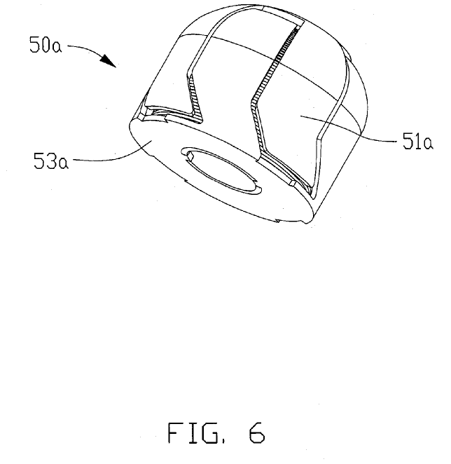

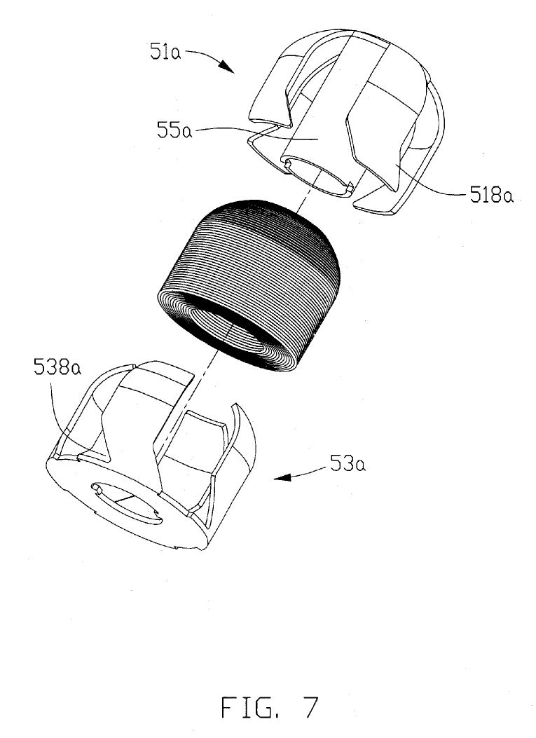

FIGS. 6-7 illustrate an alternative embodiment of the stator 50a of the electric fan. Other parts of the electric fan (not shown) in accordance with this second embodiment have substantially the same configuration as the electric fan of the previous first embodiment. In this embodiment, the stator 50a includes an upper and lower pole 51a, 53a, and a tube 55a interconnecting the poles 51a, 53a. A protrusion 518a extends from the free end of each part of the upper pole 51a along the circumferential direction thereof. A slot 538a is defined in each part of the lower pole 53a for receiving a corresponding protrusion 518a when the stator 50a is assembled together. Thus the air-gap in the electric fan is reduced.

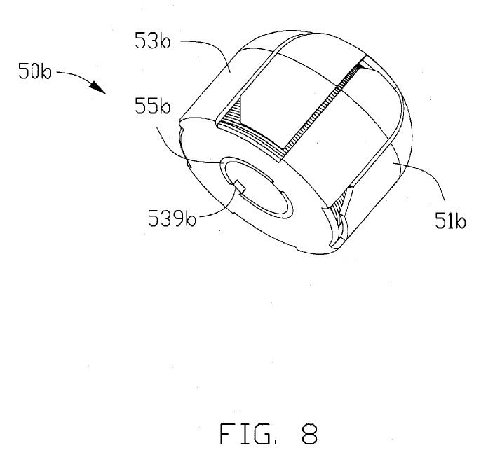

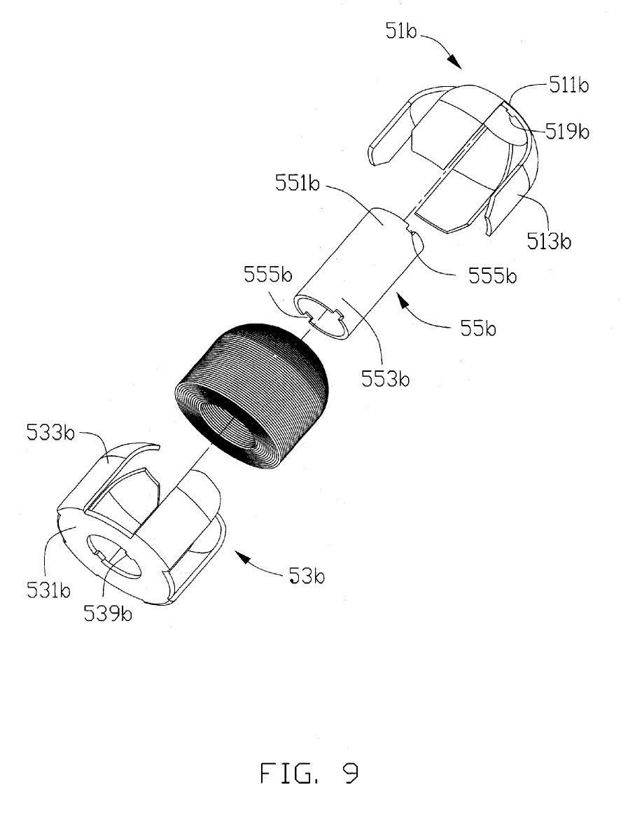

Referring to FIGS. 8-9, it illustrates a third embodiment of a stator 50b of the electric fan. In this embodiment, the tube 55b and the upper pole 51b are formed separately and then assembled together. The basewalls 511b, 531b of the upper and lower poles 51b, 53b each forms a pair of latches 519b, 539b thereon. A pair of openings 551b is defined in each of the top and bottom ends 551b, 553b of the tube 55b corresponding to the latches 519b, 539b of the upper and lower poles 51b, 53b, respectively. During assembly each latch 519b, 539b of the poles 51b, 53b engages with a corresponding opening 555b of the tube 55b to securing the assembly of the stator 50b. Alternatively, the latches 519b, 539b can be formed on the tube 55b, and the basewalls 511b, 531 b of the poles 51b, 53b can each define an opening 553b corresponding to each latch 519b, 539b of the tube 55b. Also the tube 55 (55a, 55b) and the poles 51, 53 (51a, 53a, 51b, 53b) can be assembled together in various manners, such as soldering. The tube 55 (55a, 55b) and the poles 51, 53 (51a, 53a, 51b, 53b) are made of magnetic particles formed into the shown configurations by powder metallurgy.

It is understood that the invention may be embodied in other forms without departing from the spirit thereof. Thus, the present example and embodiment is to be considered in all respects as illustrative and not restrictive, and the invention is not to be limited to the details given herein.

What is claimed is:

1. An electric fan comprising:
a frame having a central tube extending therefrom, the frame defining an air inlet and an air outlet at two different sides thereof;
a bearing received in the central tube;
a stator mounted around the central tube, the stator comprising two poles and a tube arranged between the poles, each pole comprising a basewall and a sidewall extending from the basewall, each sidewall comprising an upper portion adjacent to the air inlet expanding radially along a direction from the air inlet to the air outlet of the electric fan; and
a rotor being rotatably supported by the bearing received in the central tube.

2. The electric fan as claimed in claim 1, wherein the two poles comprise upper and lower poles, an outer diameter of the basewall of the upper pole is smaller than that of the basewall of the lower pole.

3. The electric fan as claimed in claim 2, wherein each of the sidewalls of the upper and lower poles defines a plurality of grooves dividing each sidewall into several parts, each groove of one of the sidewalls receiving a part of the other one of the sidewalls.

4. The electric fan as claimed in claim 3, wherein a protrusion extends from a free end of each part of the upper pole along a circumferential direction thereof, each part of the lower pole defines a slot receiving the protrusion.

5. The electric fan as claimed in claim 2, wherein the tube is integrally formed with the upper pole.

6. The electric fan as claimed in claim 5, wherein at least a latch is formed on the lower pole, an opening is defined in the tube receiving the at least a latch therein.

7. The electric fan as claimed in claim 2, wherein the tube and each of the poles are formed separately.

8. The electric fan as claimed in claim 1, wherein the rotor comprises a hub having a planar shaped topwall and a sidewall extending from an outer-periphery of the topwall, at least an upper portion of the sidewall of the hub corresponding to the upper portion of the sidewalls of the poles expands radially along the direction from the air inlet to the air outlet.

9. The electric fan as claimed in claim 8, wherein the rotor comprises a magnet adhered to an inner wall of the hub, the magnet comprises a ring-shaped topwall confronting the basewall of one of the poles and a sidewall confronting the sidewalls of the poles, an upper portion of the sidewall of the magnet corresponding to the upper portion of the sidewall of the hub extends from an outer-periphery of the topwall and expands radially along the direction from the air inlet to the air outlet.

10. The electric fan as claimed in claim 1, wherein the stator further comprises axial windings wound onto the tube, an upper portion of the windings configures an arc-shaped outer surface corresponding to the upper portion of the sidewalls of the poles.

11. A motor comprising:
a stator comprising:
a tube having a top end and a bottom end; and
upper and lower poles respectively connecting with the top and bottom ends of the tube, an outer diameter of an upper portion of the poles adjacent to the top end of the tube being relatively smaller than that of a lower portion of the poles adjacent to the bottom end of the tube; and
a rotor being rotatably supported by the stator.

12. The motor as claimed in claim 11, wherein each pole comprises a basewall and a sidewall extending from an outer-periphery of the basewall to the other pole, an outer diameter of the basewall of the upper pole is relatively smaller than that of the basewall of the lower pole.

13. The motor as claimed in claim 12, wherein the sidewalls expand gradually and radially along a direction from the top end to the bottom end of the tube.

14. The motor as claimed in claim 13, wherein the rotor expands radially along the direction from the top end to the bottom end of the tube.

15. The motor as claimed in claim 12, wherein each sidewall defines a plurality of grooves therein, the grooves divide each sidewall into several parts, each groove of one of the sidewalls receiving a part of the other one of the sidewalls.

16. An electric fan comprising:
a frame having an airflow inlet, an airflow outlet and a central tube between the inlet and the outlet;
a bearing received in the central tube;
a stator mounted around the central tube, the stator having an upper pole, a lower pole, a tube located in and interconnecting the upper and lower poles and coils wound around the tube; wherein the upper pole having an upper wall connecting with a top end of the tube and a side wall extending from an outer periphery of the upper wall, the side wall expanding radially along a direction from the inlet to the outlet; and
a rotor having a hub, a shaft extending from the hub to be rotatably mounted in the bearing and a plurality of fan blades extending radially outwardly from the hub, wherein the hub has a top wall and a side wall expanding radially from an outer periphery of the top wall along a direction from the inlet toward the outlet.
